(19) United States
(12) Patent Application Publication
(10) Pub. No.: US 2012/0249493 A1
(43) Pub. Date: Oct. 4, 2012

(54) GATE DRIVER OF DUAL-GATE DISPLAY AND FRAME CONTROL METHOD THEREOF

(75) Inventors: Chia-Yin Chiang, Hsinchu County (TW); Tzu-Chien Huang, Taoyuan County (TW); Chia-Sheng Chang, Hsinchu County (TW)

(73) Assignee: NOVATEK MICROELECTRONICS CORP., Hsinchu (TW)

(21) Appl. No.: 13/369,279

(22) Filed: Feb. 8, 2012

(30) Foreign Application Priority Data
Mar. 30, 2011 (TW) 100111070

(51) Int. Cl. G09G 5/00

(52) U.S. Cl. 345/204

(57) ABSTRACT

A gate driver of a dual-gate display is provided. The gate driver includes a shift register and an odd/even (O/E) switching unit. The shift register receives a clock signal and a start pulse (STV). The shift register outputs a plurality of gate line driving signals after being activated by the STV. Every adjacent two of the gate line driving signals form a pair of gate signals indicated as a first signal and a second signal. The O/E switching unit receives the gate line driving signals and a switching control signal. The switching control signal has a first state and a second state. The first state activates the pair of gate signals in a first sequence from the first signal to the second signal, and the second state activates the pair of gate signals in a second sequence from the second signal to the first signal.

### CROSS-REFERENCE TO RELATED APPLICATION

This application claims the priority benefit of Taiwan application serial no. 100111070, filed on Mar. 30, 2011. The entirety of the above-mentioned patent application is hereby incorporated by reference herein and made a part of this specification.

### BACKGROUND OF THE INVENTION

1. Field of the Invention

The invention relates to a gate driver of a dual-gate display and a frame control method thereof.

2. Description of Related Art

A liquid crystal display (LCD) displays images under the control of a gate driver and a source driver, wherein the gate driver controls gate lines. FIG. 1 is diagram illustrating the signals for driving gate lines in a conventional gate driver.

Referring to FIG. 1, the gate driver controls the turning-on sequence of gate output channels by using a shift register. To be specific, after the gate driver activates the shift register by using a start pulse (STV), the gate output channels (denoted as GO1, GO2, GO3, and GO4, etc.) sequentially turned on and turn off according to a clock signal (CLK). Thereafter, image data is input from the sources when pixels connected to these gate output channels are turned on by gate signals.

In order to reduce the fabrication cost of LCD, conventionally, a dual-gate structure is adopted as the pixel structure of LCD. Regarding the operation of the dual-gate structure, two adjacent odd and even pixels are respectively driven by the same source during the time of a horizontal line, so that the number of sources can be reduced by half but the number of gates has to be doubled. The fabrication cost of a conventional LCD in which the number of sources is greater than the number of gates can be reduced by adopting such a dual-gate structure.

FIG. 2 is a diagram illustrating the gate turning-on sequence in a conventional dual-gate structure. Referring to FIG. 2, regarding a horizontal synchronous signal in a line display mode, the gate lines GO1 and GO2 are two gate lines belonging to a same horizontal line, the gate lines GO3 and GO4 are two gate lines belonging to a next horizontal line, and so on. The gate lines can be categorized into odd gate lines (for example, the gate lines GO1, GO3, etc) and even gate lines (for example, the gate lines GO2, GO4, etc). Tgo is the timing for turning on an odd gate line, and Tge is the timing for turning on an even gate line.

According to the conventional technique, if a structure in which odd sources and even sources share positive and negative digital-to-analog converters (DACs) is adopted along with the dual-gate driving technique, a 2-dot or 1+2-dot invert driving mechanism will appear in the pixel array of a dual-gate LCD.

FIG. 3 is a diagram illustrating the turning-on sequence of gate lines under the 1+2-(dot) invert driving mechanism. Referring to FIG. 3, parts of four display lines in the pixel array are taken as examples, and which are controlled by the gate lines GO1-GO8 and the source lines SO1-SO5. When the gate lines are turned on, the source lines SO1-SO5 input pixel grayscale data. Because the dual-gate structure is adopted, the two adjacent gate lines GO1 and GO2 form a pair, and the source lines alternatively input the pixel grayscale data with different voltage polarities (as indicated by the symbols +/−). The colors to be displayed by pixels may be red, green, and blue (indicated as RGB). Regarding a display line perpendicular to the source lines, the turning-on sequence of the gate lines is as indicated by the dotted line, and which is also referred to as a Z mode.

When the gate lines are driven in the Z mode, uneven brightness will be produced on the vertical lines of a displayed image. FIG. 4 is a diagram illustrating the brightness variation on vertical lines of an image displayed in the Z mode. FIG. 5 is a diagram illustrating the variation of voltage polarities on gate lines corresponding to a source line. Referring to FIG. 5, the horizontal lines are corresponding to a source line, while the vertical lines are sequentially controlled by the gate lines. If the gate lines are driven in the Z mode, alternative brightness variations will be produced in the image, and the reason of this phenomenon is illustrated in FIG. 5. Referring to FIG. 3 and FIG. 5, taking the source line SO1 as an example, the gate lines corresponding to the source line SO1 are turned on in the Z mode, and the voltage polarity varies in a pattern of “+−−++−− . . . ”. When the even gate lines are turned on, the voltage on the source line is in an under-charged state. However, when the odd gate lines are turned on, the voltage on the source line is in a fully-charged state. Thus, the even pixels cannot display the desired grayscales correctly and accordingly produce darker lines.

FIG. 6 is a diagram illustrating a conventional invert-Z driving mode. Referring to FIG. 6, in the invert-Z mode, the turning-on sequence of the gate lines illustrated in FIG. 3 (i.e., GO1→GO2→GO3→GO4→GO5→GO6→GO7→GO8 . . . ) is corrected to GO2→GO1→GO4→GO3→GO6→GO5→GO8→GO7 . . . . In addition, the symbols +/− also come in a reverse sequence when the voltage polarities on the source lines remain the same.

FIG. 7 is a diagram illustrating the brightness variation on vertical lines of an image displayed in the invert-Z mode. FIG. 8 is a diagram illustrating the variation of voltage polarities on gate lines corresponding to a source line. Referring to FIG. 7 and FIG. 8, due to the same reason, in the invert-Z mode, the odd pixels are also in an under-charged state. As a result, the odd vertical lines are darker.

In order to resolve aforementioned problems, conventionally, a driving technique based on a time-averaged mechanism is further provided. FIGS. 9A-9B are diagrams illustrating conventional gate driving modes. Referring to FIGS. 9A-9B, FIG. 9A illustrates the Z mode in FIG. 3, and FIG. 9B illustrates the invert-Z mode in FIG. 6. According to the time-averaged mechanism, different gate line turning-on sequence is adopted during each frame time (i.e., the Z mode and the invert-Z mode are adopted during different time periods), so that a uniform visual effect can be achieved and vertical dark lines can be made unnoticeable to human eyes by driving the gate lines in different sequences at different time. FIG. 10 is a diagram illustrating the brightness variation on vertical lines of an image displayed in the time-averaged Z mode and invert-Z mode. Referring to FIG. 10, a uniform brightness is achieved on the vertical lines through the time-averaged mechanism.

However, in the conventional driving techniques described above, only one gate driving mode can be adopted in a display image, which is not flexible.

### SUMMARY OF THE INVENTION

Accordingly, the invention is directed to a gate driver of a dual-gate display and a frame control method thereof.

The invention provides a gate driver of a dual-gate display. The gate driver includes a shift register and an odd/even (O/E) switching unit. The shift register receives a clock signal and a start pulse (STV). After being activated by the STV, the shift register outputs a plurality of gate line driving signals, wherein every adjacent two of the gate line driving signals form a pair of gate signals indicated as a first signal and a second signal. The O/E switching unit receives the gate line driving signals and a switching control signal. The switching control signal has a first state and a second state. The first state activates the pair of gate signals in a first sequence (from the first signal to the second signal), and the second state activates the pair of gate signals in a second sequence (from the second signal to the first signal).

The invention also provides a frame control method of a dual-gate display. The frame control method includes sending a clock signal and a STV to a shift register, wherein the shift register outputs a plurality of gate line driving signals after it is activated by the STV, and every adjacent two of the gate line driving signals form a pair of gate signals indicated as a first signal and a second signal. The frame control method also includes sending a switching control signal to an O/E switching unit to switch the output sequence of the gate line driving signals, wherein the switching control signal has a first state and a second state, the first state outputs the pair of gate signals in a first sequence (from the first signal to the second signal), and the second state outputs the pair of gate signals in a second sequence (from the second signal to the first signal). The frame control method further includes generating an output sequence of the gate line driving signals according to a combination of the first state and the second state of the switching control signal, so as to control the display of a plurality of lines.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and the drawings together with the description serve to explain the principles of the invention.

FIG. 1 is diagram illustrating the signals for driving gate lines in a conventional gate driver.

FIG. 2 is a diagram illustrating the gate turning-on sequence in a conventional dual-gate structure.

FIG. 3 is a diagram illustrating the turning-on sequence of gate lines under the 1+2-dot invert driving mechanism.

FIG. 4 is a diagram illustrating the brightness variation on vertical lines of an image displayed in the Z mode.

FIG. 5 is a diagram illustrating the variation of voltage polarities on a source line corresponding to the gate line.

FIG. 6 is a diagram illustrating a conventional invert-Z driving mode.

FIG. 7 is a diagram illustrating the brightness variation on vertical lines of an image displayed in the invert-Z mode.

FIG. 8 is a diagram illustrating the variation of voltage polarities on a source line corresponding to the gate line.

FIGS. 9A-9B are diagrams illustrating conventional gate driving modes.

FIG. 10 is a diagram illustrating the brightness variation on vertical lines of an image displayed in the time-averaged Z mode and invert-Z mode.

FIG. 11 is a diagram illustrating a gate line driving mode according to an embodiment of the invention.

FIG. 12 is a diagram illustrating a pixel charging mechanism in the gate line driving mode in FIG. 11 according to an embodiment of the invention.

FIG. 13 is a block diagram of a gate driver of a dual-gate display according to an embodiment of the invention.

FIG. 14 is a diagram illustrating a Z mode control mechanism according to an embodiment of the invention.

FIG. 15 is a diagram illustrating a C/invert-C mixed mode control mechanism according to an embodiment of the invention.

FIG. 16 is a diagram illustrating a C+Z mode control mechanism according to an embodiment of the invention.

FIG. 17 is a diagram illustrating an invert-Z mode control mechanism according to an embodiment of the invention.

FIGS. 18-21 are diagrams illustrating the timing relationships between gate signals and a signal F_Ctrl corresponding to FIGS. 14, 17, 15 and 16.

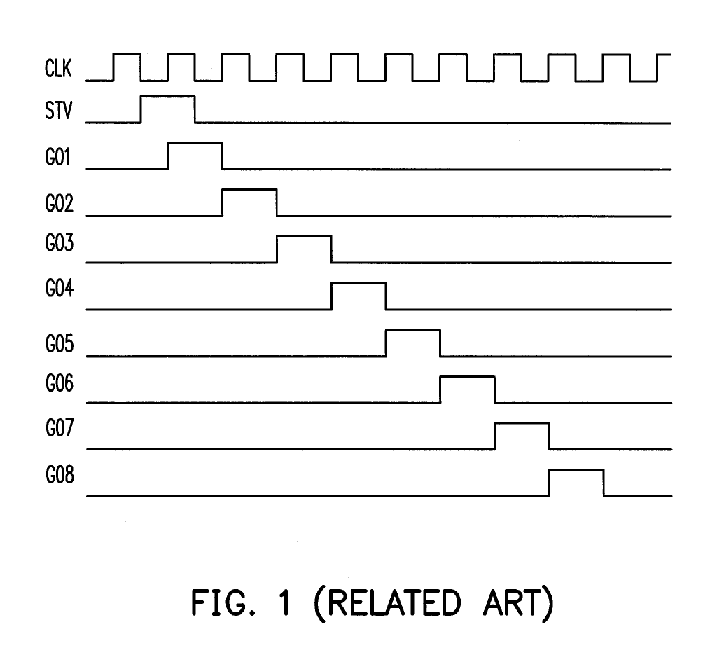

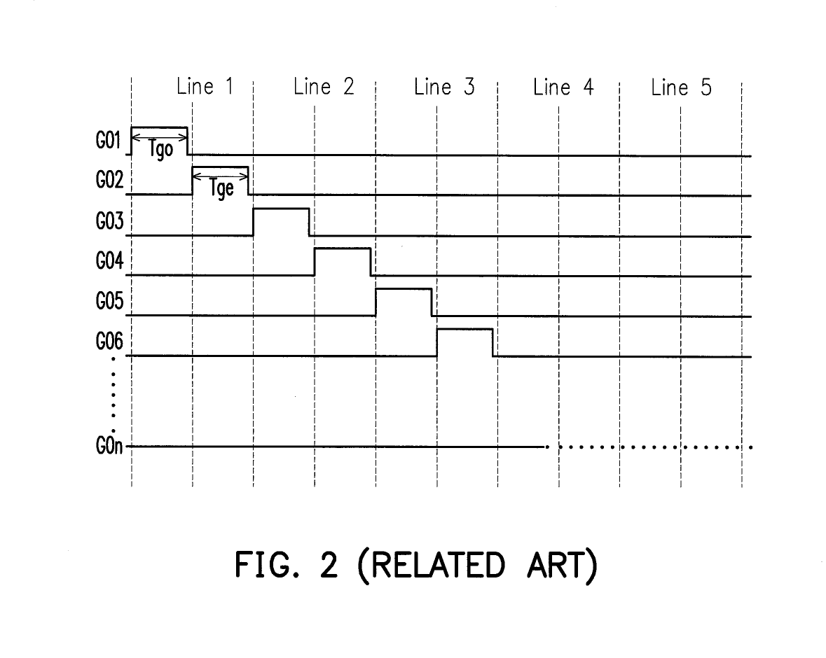

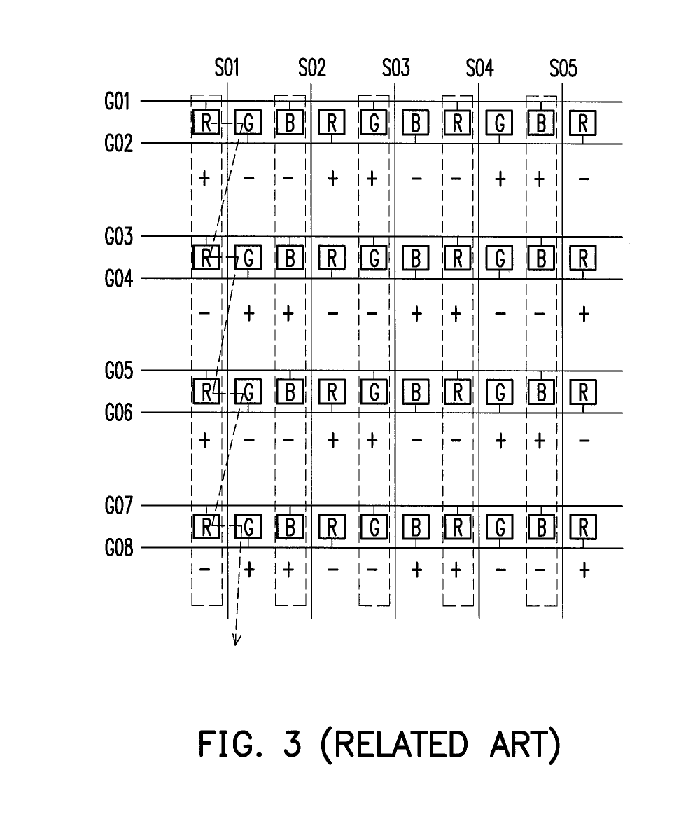

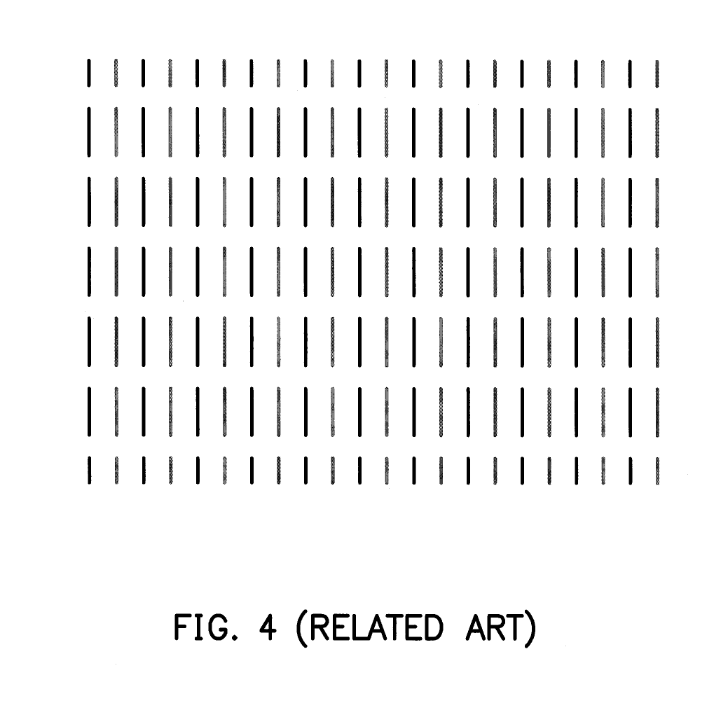

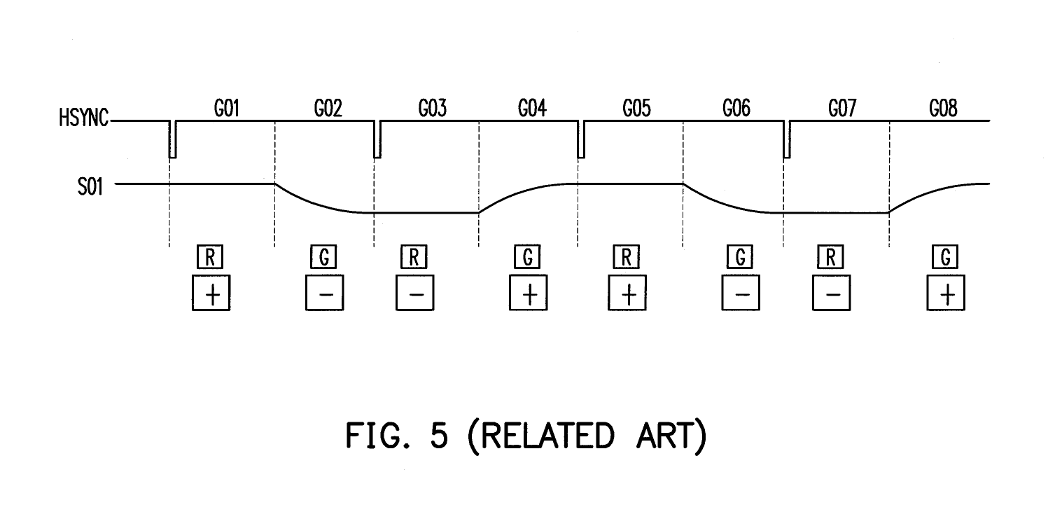

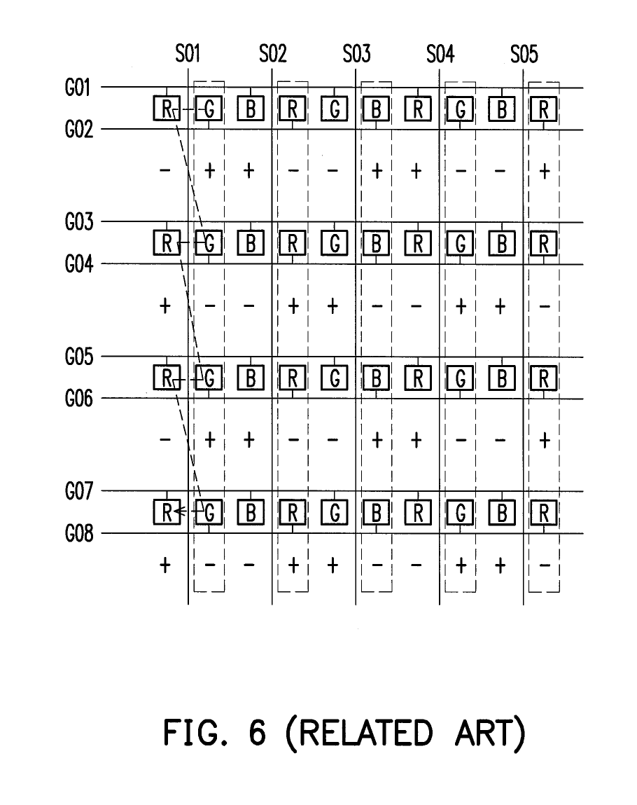

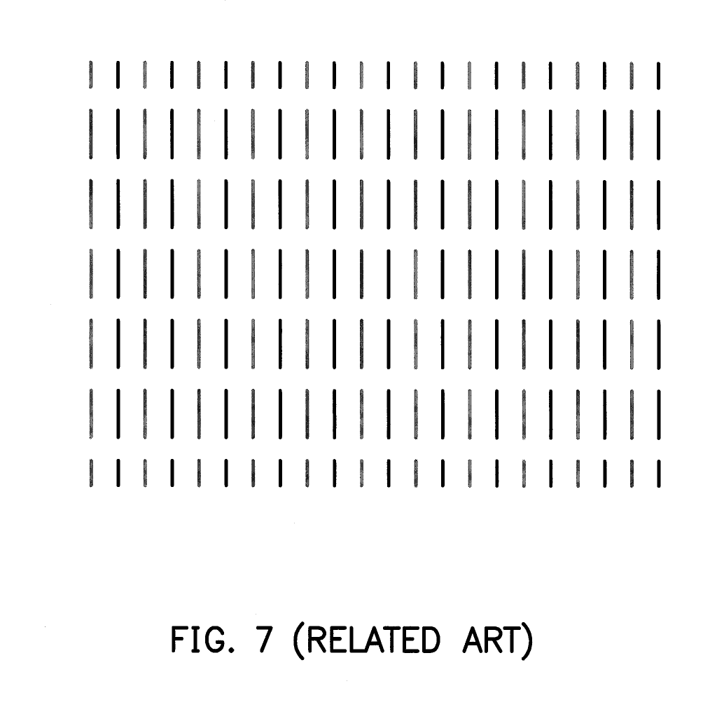

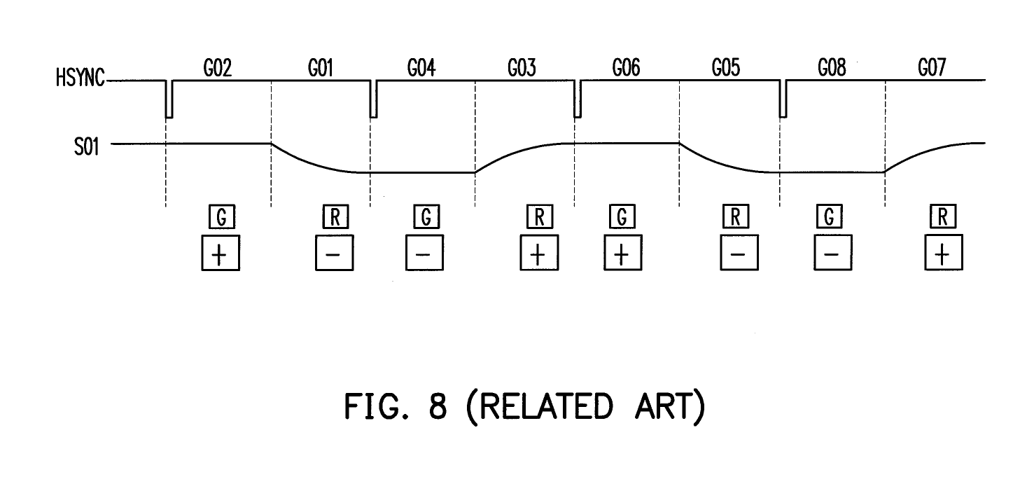

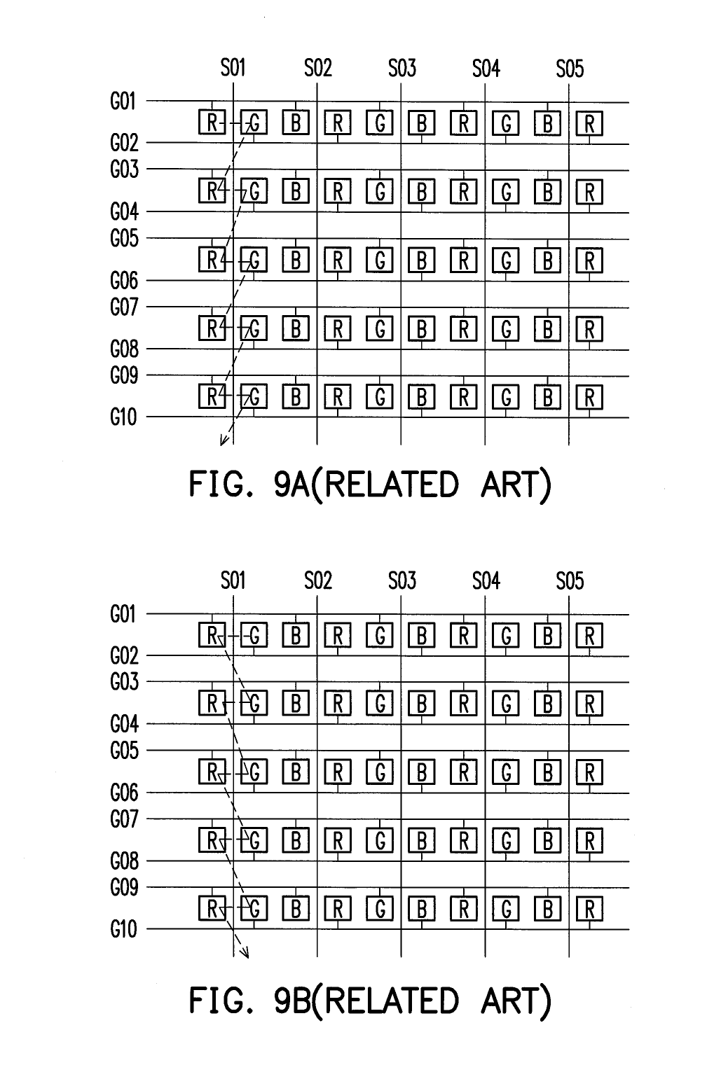

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The invention provides a technique for reducing dark lines in a displayed image. Below, embodiments of the invention will be described. However, these embodiments are not intended to limit the scope of the invention, and these embodiments can be appropriately combined.

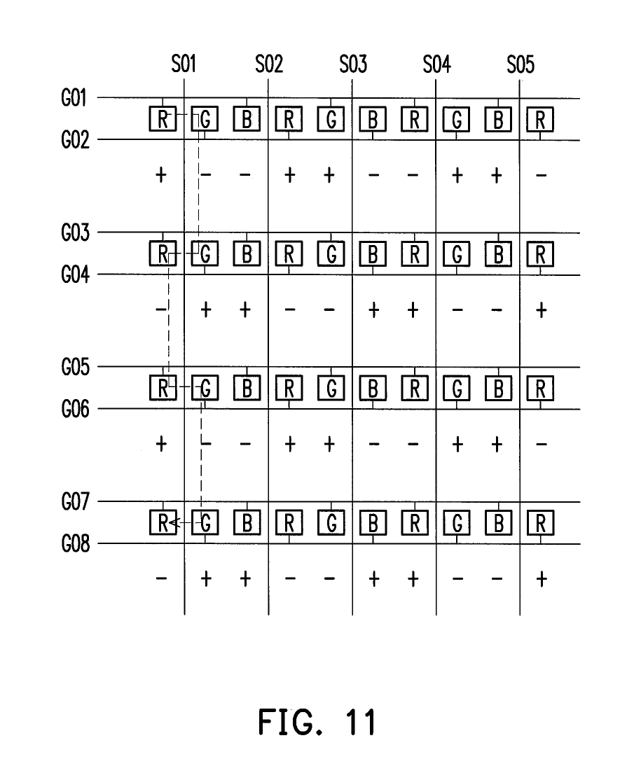

The invention provides a gate line driving mechanism compatible to conventional gate driving modes and various mixed gate driving modes. Besides, the invention also provides a driving technique based on the space-averaged mechanism, wherein the gate turning-on sequence on each display line is changed. FIG. 11 is a diagram illustrating a gate line driving mode according to an embodiment of the invention. Referring to FIG. 11, turning-on sequence of gate lines in the C/invert-C mixed driving mode is defined as: GO1→GO2→GO4→GO3→GO5→GO6→GO8→GO7 . . . .

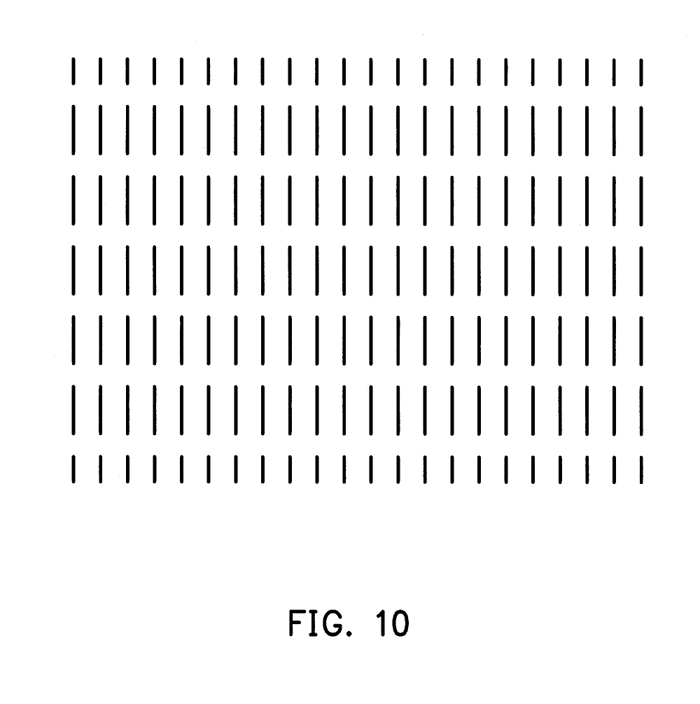

During the same frame time, each display line is switched between the invert-C and C modes to achieve a driving sequence as indicated by the doted line, so that a space-averaged effect can be achieved. Dark lines in a display image can be reduced (as shown in FIG. 10) through time- or space-averaging.

Based on the same mechanism and the same effect, the turning-on sequence of the gate lines may also be changed to a C/invert-C mixed mode: GO2→GO1→GO3→GO4→GO6→GO5→GO7→GO8 . . . .

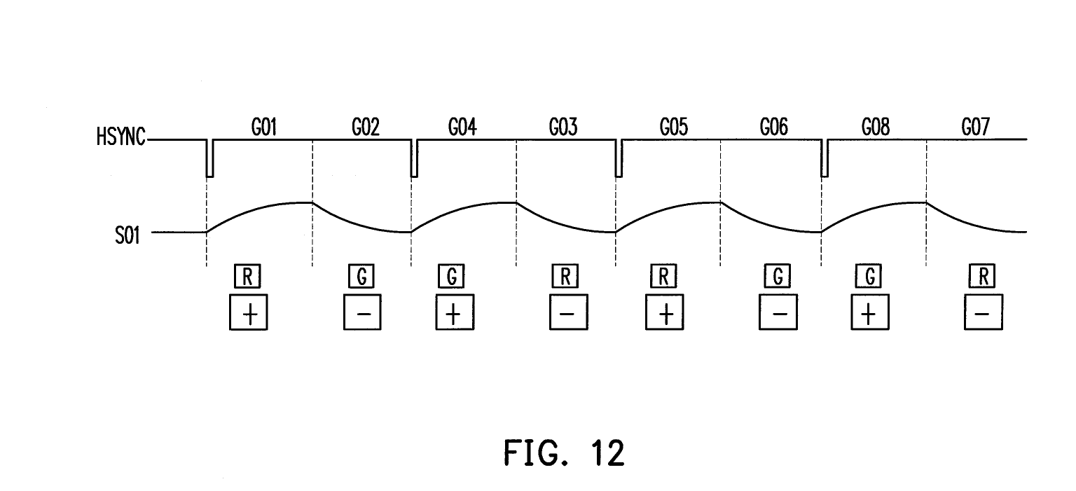

FIG. 12 is a diagram illustrating a pixel charging mechanism in the gate line driving mode in FIG. 11 according to an embodiment of the invention. Referring to FIG. 12, pixel data input from the source line SO1 is taken as an example, and the horizontal synchronous signal is indicated as HSYNC. Even though the odd pixels and even pixels are all in an under-charged state, these pixels are in very close states. Thus, the brightness presented by these pixels is very close and no obvious brightness variation can be observed. Herein the colors to be displayed by the pixels are indicated as RGB, but the embodiment is not limited thereto.

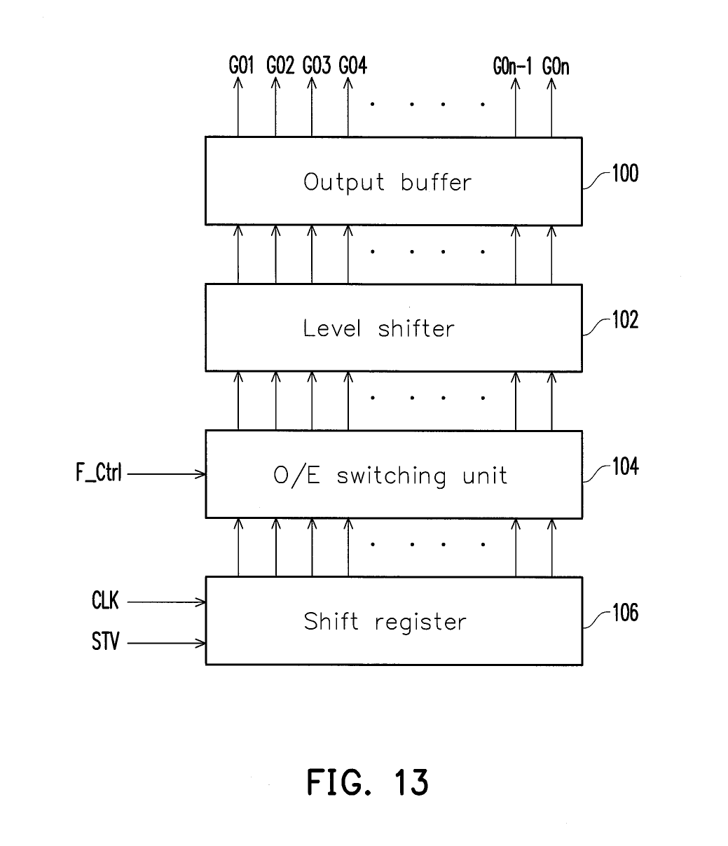

An odd/even (O/E) switching unit is disposed in the circuit of a gate driver such that different driving modes can be selected according to the actual requirement through a single control signal F_Ctrl. FIG. 13 is a block diagram of a gate driver of a dual-gate display according to an embodiment of the invention. Referring to FIG. 13, the gate driver of the dual-gate display includes various units, and those parts related to the invention will be described below.

The gate driver of the dual-gate display includes a shift register 106. The shift register 106 receives a clock signal CLK and a start pulse STV. The shift register 106 outputs a plurality of gate line driving signals after being activated by the start pulse STV, wherein every adjacent two of the gate line driving signals form a pair of gate signals indicated as a first signal and a second signal.

An odd/even (O/E) switching unit 104 receives the gate line driving signals and a switching control signal F_Ctrl. The switching control signal F_Ctrl has a first state and a second state, wherein the first state activates the pair of gate signals in a first sequence (from the first signal to the second signal), and the second state activates the pair of gate signals in a second sequence (from the second signal to the first signal).

Voltages on the gate line driving signals switched by the O/E switching unit 104 are adjusted by a level shifter unit 102. The adjusted gate line driving signals G1-Gn are output by an output buffer 100 to drive the connected pixels.

Below, the operation mechanism of the O/E switching unit 104 will be further described. Two states of the switching control signal F_Ctrl control the gate lines respectively in following sequences:

F_Ctrl=L: GOn(odd)−>GOn(even):

F_Ctrl=H: GOn(even)−>GOn(odd).

Namely, regarding the display of one horizontal line, if F_Ctrl=L (L represents a low level), the turning-on sequence of the gate lines is from odd gate line to even gate line. Contrarily, if F_Ctrl=H (H represents a high level), the turning-on sequence of the gate lines is from even gate line to odd gate line.

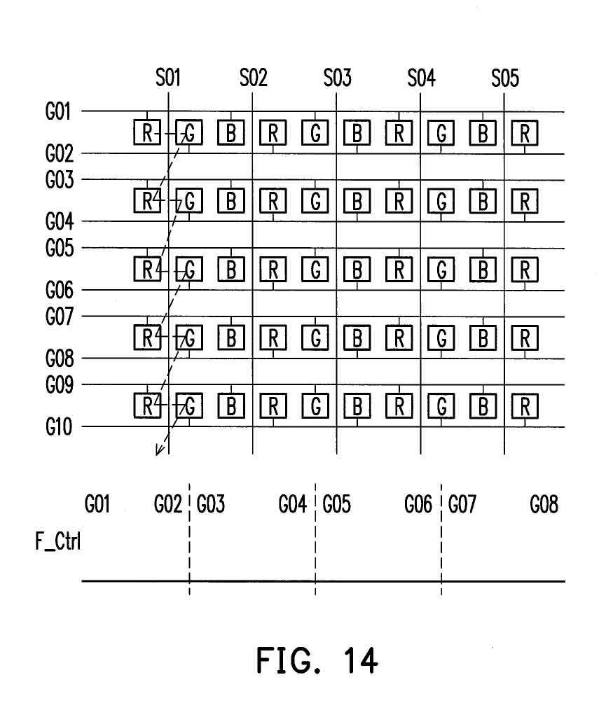

Various control modes can be accomplished through switching of the two states of the switching control signal F_Ctrl. FIG. 14 is a diagram illustrating a Z mode control mechanism according to an embodiment of the invention. Referring to FIG. 14, when the switching control signal F_Ctrl remains in the state L, the turning-on sequence is from odd gate line to even gate line, and accordingly a Z-mode turning-on sequence is accomplished.

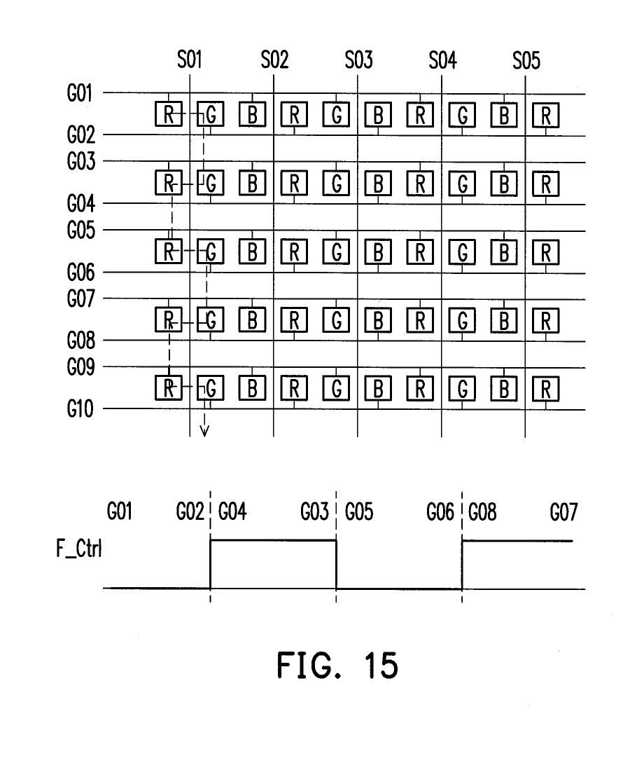

FIG. 15 is a diagram illustrating an invert-C/C mixed mode control mechanism according to an embodiment of the invention. Referring to FIG. 15, when the switching control signal F_Ctrl alternatively switches between the states L and H and it switches from the state L to the state H, the turning-on sequence of the gate lines is from odd gate line to even gate line and accordingly an invert-C mode turning-on sequence is accomplished. When the switching control signal F_Ctrl switches from the state H to the state L, the turning-on sequence of the gate lines is from even gate line to odd gate line, and accordingly a C mode turning-on sequence is accomplished. Thereby, an invert-C/C mixed mode is achieved.

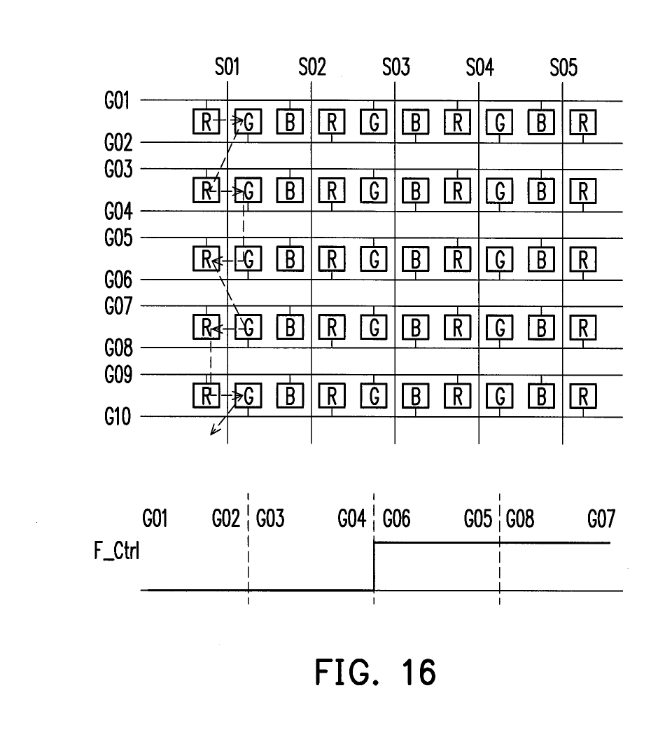

FIG. 16 is a diagram illustrating a C+Z mode control mechanism according to an embodiment of the invention. Referring to FIG. 16, the switching control signal F_Ctrl alternatively switches between the states L and H and remains in each state for a time period required for turning on four gate lines. When the switching control signal F_Ctrl switches from odd gate line to even gate line in the state L, a Z mode turning-on sequence is accomplished. When the switching control signal F_Ctrl switches from even gate line to odd gate line in the state H, an invert-C mode turning-on sequence is accomplished regarding the four gate lines GO3-GO6 switched between the states L and H. Thereby, a C+Z mixed mode is achieved.

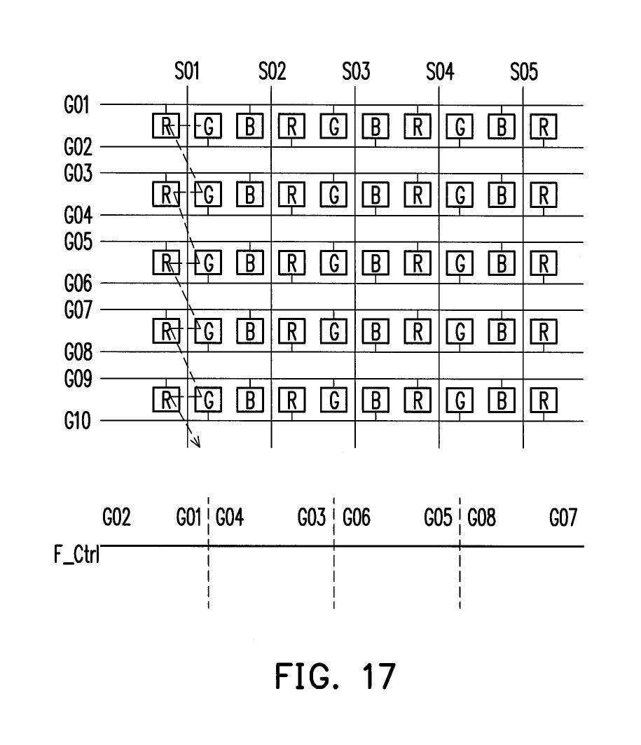

FIG. 17 is a diagram illustrating an invert-Z mode control mechanism according to an embodiment of the invention. Referring to FIG. 17, when the switching control signal F_Ctl remains in the state H, the turning-on sequence is from even gate line to odd gate line, so that an invert-Z mode turning-on sequence.

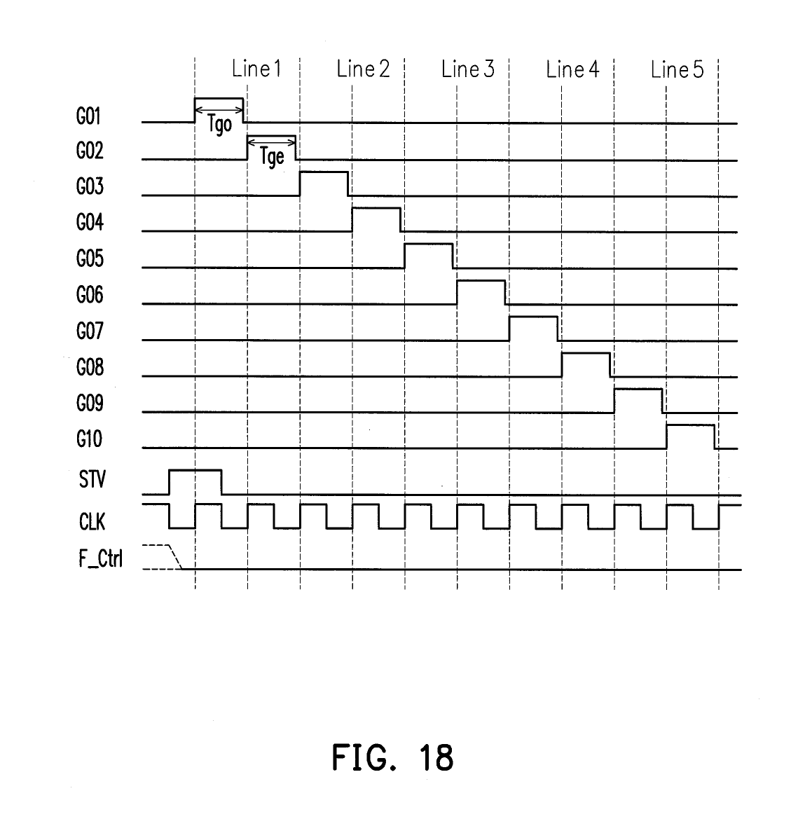

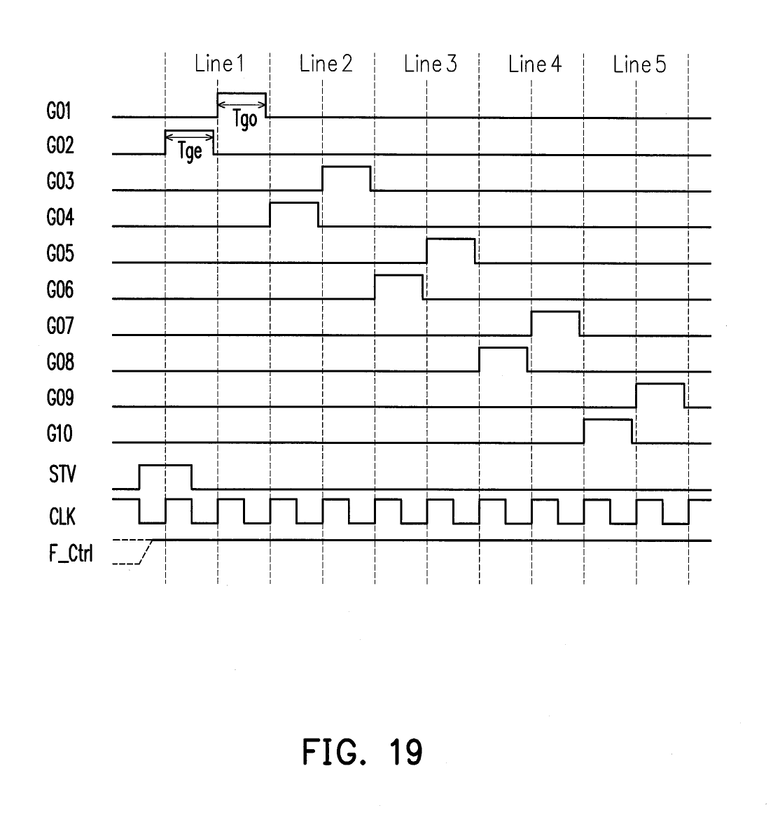

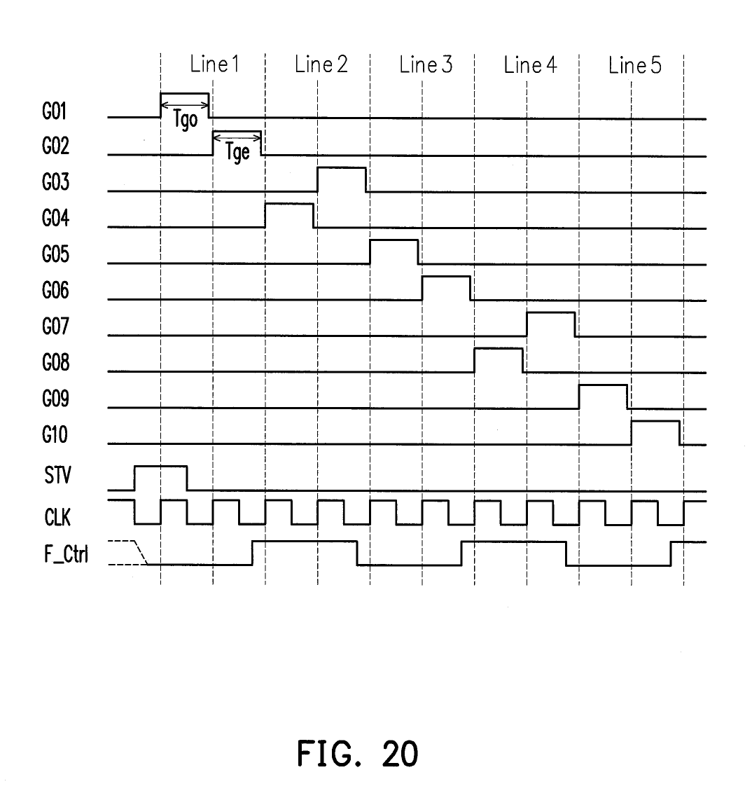

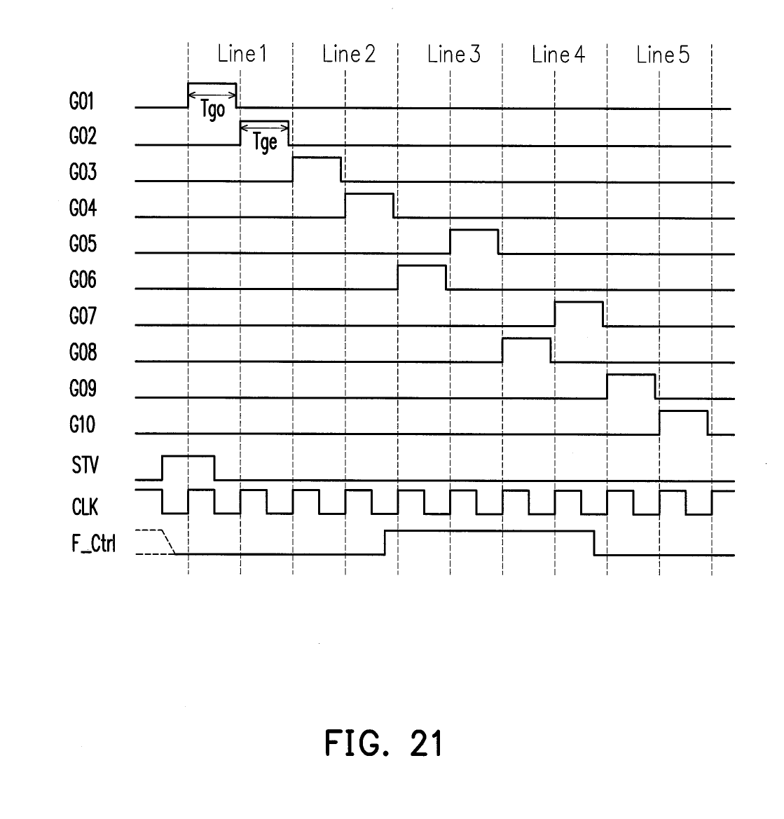

FIGS. 18-21 are diagrams illustrating the timing relationships between gate signals and a signal F_Ctrl corresponding to FIGS. 14, 17, 15 and 16. Referring to FIG. 18, the switching control signal F_Ctrl remains in the state L. Thus, the turning-o sequence of the gate lines is from odd gate line to even gate line, so that a Z mode turning-on sequence is accomplished. Referring to FIG. 19, the switching control signal F_Ctrl remains in the state H. Thus, the turning-on sequence of the gate lines is from even gate line to odd gate line, so that an invert-Z mode turning-on sequence is accomplished. Referring to FIG. 20, the switching control signal F_Ctrl alternatively switches between the states L and H so that an invert-C/C mixed mode turning-on sequence is accomplished. Referring to FIG. 21, the switching control signal F_Ctrl alternatively switches between the states L and H but remains in each state for the time required for driving four gate lines, so that a C/Z mixed mode turning-on sequence is accomplished. Herein the states L and H of the switching control signal F_Ctrl can be exchanged. Namely, more than aforementioned four modes can be actually accomplished.

The invention provides a gate driving technique which can achieve a space-averaged effect. In addition, regarding the hardware control, a single control input is required. For example, a mode among four optional modes can be selected by using a single control signal, so that it is not needed to identify the four optional modes by using two control terminals.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A gate driver of a dual-gate display, comprising:
a shift register, receiving a clock signal and a start pulse (STV), for outputting a plurality of gate line driving signals after being activated by the STV, wherein every adjacent two of the gate line driving signals form a pair of gate signals indicated as a first signal and a second signal; and
an odd/even (O/E) switching unit, receiving the gate line driving signals and a switching control signal, wherein the switching control signal has a first state and a second state, the first state activates the pair of gate signals in a first sequence, and the second state activates the pair of gate signals in a second sequence, wherein the first sequence is from the first signal to the second signal, and the second sequence is from the second signal to the first signal.

2. The gate driver according to claim 1, wherein the switching control signal remains in the first state so that the gate line driving signals are in a Z driving mode.

3. The gate driver according to claim 1, wherein the switching control signal remains in the second state so that the gate line driving signals are in an invert-Z driving mode.

4. The gate driver according to claim 1, wherein the switching control signal switches between the first state and the second state so that the gate line driving signals are in a C/invert-C mixed driving mode.

5. The gate driver according to claim 1, wherein the switching control signal switches between the first state and the second state at an interval of two horizontal display lines, so that the gate line driving signals are in a Z/C/invert-Z/invert-C mixed driving mode.

6. The gate driver according to claim 1, wherein the O/E switching unit generates an output sequence of the gate line driving signals according to a combination of the first state and the second state of the switching control signal.

7. The gate driver according to claim 1, wherein the switching control signal is input from a single input terminal.

8. The gate driver according to claim 1, wherein the dual-gate display is in a 1+2-dot invert driving mode.

9. A frame control method of a dual-gate display, comprising:
providing a clock signal and a start pulse (STV) to a shift register, wherein the shift register outputs a plurality of gate line driving signals after being activated by the STV, and every adjacent two of the gate line driving signals form a pair of gate signals indicated as a first signal and a second signal;
providing a switching control signal to an O/E switching unit to switch an output sequence of the gate line driving signals, wherein the switching control signal has a first state and a second state, the first state outputs the pair of gate signals in a first sequence, and the second state outputs the pair of gate signals in a second sequence, wherein the first sequence is from the first signal to the second signal, and the second sequence is from the second signal to the first signal; and
generating an output sequence of the gate line driving signals according to a combination of the first state and the second state of the switching control signal, so as to control the display of a plurality of lines.

10. The frame control method according to claim 9, wherein the switching control signal remains in the first state so that the gate line driving signals are in a Z driving mode.

11. The frame control method according to claim 9, wherein the switching control signal remains in the second state so that the gate line driving signals are in an invert-Z driving mode.

12. The frame control method according to claim 9, wherein the switching control signal switches between the first state and the second state so that the gate line driving signals are in a C/invert-C mixed driving mode.

13. The frame control method according to claim 9, wherein the switching control signal switches between the first state and the second state at an interval of two horizontal display lines, so that the gate line driving signals are in a Z/C/invert-Z/invert-C mixed driving mode.

14. The frame control method according to claim 9, wherein the switching control signal is input from a single input terminal.

15. The frame control method according to claim 9, wherein the dual-gate display is in a 1+2-dot invert driving mode.
